(19) United States
(12) Patent Application Publication
(10) Pub. No.: US 2009/0208626 A1
(43) Pub. Date: Aug. 20, 2009

(54) BROCCOLI FLORETING SYSTEMS AND METHODS

(75) Inventors: Mike Jarrard, Salinas, CA (US); Jason Tracy, Salinas, CA (US); Hugo Cazares, Morgan Hill, CA (US); Albert Norman, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mann Packing Co., Inc., Salinas, CA (US)

(21) Appl. No.: 12/033,791

(22) Filed: Feb. 19, 2008

(51) Int. Cl. A23P 1/10; A23N 15/00

(52) U.S. Cl. 426/518; 99/635; 99/642; 99/643

(57) ABSTRACT

Broccoli heads are placed individually, stem down, in transporting cups that are affixed to a conveyor that at one end rotates around a carousel axis. A clamping and cutting assembly includes linkages rotating around the carousel axis synchronously with the transporting cups on the conveyor. Retractable clamps affixed to an upper linkage retain the broccoli heads while curved blades that are affixed to a lower linkage dissect the broccoli. The blades cut off the florets with a scooping motion along the bottom side of the transporting cups which results in similar sized florets, standardized by the diameter of the truncated cone-shaped chamfer of the cups. Upon dissection the florets are released from the cups and collected on a collecting conveyor.

### BACKGROUND

The present invention relates generally to methods and devices for floreting broccoli, and more particularly to systems and methods for automatically dissecting broccoli heads in florets and stems.

Various methods and machines that are directed to a broccoli floreting processes and apparatus are well known in the art. Cutting broccoli heads by hand with an ordinary cutting device is an easily available and flexible method to floret broccoli heads. However, these manual processes are disadvantageous because they are time consuming processes that require high amounts of manpower. Different mechanical procedures speed up the processing time through the use of automated and semi-automated machines. These machines cut the broccoli mainly in an upside down position which causes instability and, therefore yields less efficient cutting results. It is desirable to achieve a more consistent diameter of the stem from the floreting process. Previous automated and semi-automated broccoli floreting machines yield broccoli heads of varying size. Consequently, such dimensional variance results in vast amounts of scrap because the changes in broccoli head dimensions does not allow for consistent cutting locations between the broccoli head elements and the automated machine cutting implements.

Another approach known in the art uses two cutting blades that cut the broccoli from both sides to attempt to address these shortcomings. However, the constant clashing of the blades in their contact point entails apace abrasion and inaccurate cuts. Also, the constant clashing of the blades leads to higher maintenance costs of replacement parts and greater machine downtime.

Another well known process is a core removal device that features two blades folding up. The blades are affixed on a sliding support that moves perpendicular to a conveyor means layer and is equipped with an adjustable regulator that allows vertical tuning as well as offset modulation. However, this approach does not allow the dimensional consistency to eliminate scrap and further exhibits many of the machine downtime drawbacks previously discussed.

Another similar process is a device that features pivotably mounted blades for cutting movement in which the cutting edges follow an accurate path to achieve a complete removal of the stem. These blades are also connected together and are formed with cutting edges which open and close in the manner of a beak. The cutter elements are mounted on a carrier plate which is pivotable between the cutting and core discharge positions about a pivot axis to one side of and parallel with a conveyor means. It misses however any further means for fixture.

A broccoli head trimming apparatus variably and shakily holding the heads by an inflatable elastomeric collar that transports the broccoli on a conveyor means was also developed for bulk processing of broccoli heads. When the broccoli head approaches the trimming station the machine's conveyor means is slowed down and enables a guillotine blade to cut of the florets. This movement and the collection of the cut off florets falling down by gravity on a lower level, increases the machines loss ratio of such processes.

Another previously developed process features a clamping portion that can be opened and closed and transports vegetable around the plane of the loop. When the clamping portion is in its closed position and the stalks are affixed in its holding portion, a rotary saw cuts off the stalks. However, this approach does not provide for a proper and complete removal of the cores according to the peculiar form of stems and florets, thus resulting in high amounts of scrap as well.

Several further approaches have been developed to slice broccoli heads into spears. A device using this approach divides the heads into multiple segments by a segmenting knife and, then, separates the florets by use of a spinning, semispherical cutter. To sever the florets, such a cutter sweeps through approximately ninety degrees. Alternatively, the broccoli can be transported while laying on its side. A clamping jaw grasps the stems end of a broccoli, straightens them up and a slicing means that is mounted in a vertically aligned relation for joint rotational movement separates the florets. The slicing means provides a plurality of straight knife blades angularly related to each other for providing a plurality of longitudinal slices, severing the broccoli head in spears. The drawback to these methods is that they are instable and don't provide for accurate cuts, again leading to high amounts of scrap and ultimately higher processing costs.

Therefore it is desirable to provide a faster and more efficient methods of floretting broccoli.

### BRIEF SUMMARY

Systems, apparatus and methods for floretting broccoli heads includes a conveyor track having a plurality of cups for holding broccoli heads. Broccoli heads are placed individually, stem down, in transporting cups that are affixed to the conveyor that at one end rotates around a carousel axis. A clamping and cutting assembly includes linkages rotating around the carousel axis synchronously with the transporting cups on the conveyor. Retractable clamps affixed to an upper linkage retain the broccoli heads while curved blades affixed to a lower linkage dissect the broccoli. The blades cut off the florets with a scooping motion along the bottom side of the transporting cups which results in similar sized florets, standardized by the diameter of the truncated cone-shaped chamfer of the cups. Upon dissection the florets are released from the cups and collected on a collecting conveyor. Embodiments and aspects of the present invention are also applicable to cutting cauliflower heads.

In certain aspects, an apparatus for processing broccoli heads includes a two-layered conveyor system. Two horizontally parallel levels of rotary four-bar linkages constitute the first axes of the transporting tracks. The upper level features clamps for holding broccoli heads and the lower level includes the blades on each end of an arm. In one aspect, the second axis of the tracks is in a releasing zone where the cut off broccoli heads are disposed when the cups temporarily drop away. The carrier cups receiving the broccoli heads travel on the conveyor in a manner such that a clamping and cutting mechanism moving in a concurrent path engages an unprocessed broccoli head element held in a receiving cup and cut the head element to form broccoli florets (head) and a broccoli stem.

According to one aspect of the present invention, the continuously fed broccoli heads pass through multiple stations or zones. In one aspect, the head is clamped in a first zone and cut by the blades with a scooping motion in a second zone. Next, the clamps release the heads and retract in a third zone. Thereafter, the transporting cups drop the heads at a second pivot point in a releasing zone. The cut off stems are subsequently collected on the lower conveyor and carried away for secondary treatment.

Another aspect of the present invention is that the blades' radius equals the recess curve of the bottom side of the receiving cups. Also, the blades approach the broccoli from behind and cut the broccoli in equally sized florets, standardized by the diameter and the dent of the transporting cup in which the broccoli heads are inserted stem ahead.

One embodiment of the present invention is the industrial fixed mounted application of the device wherein the apparatus is mounted in a fixed location and the broccoli heads are transported to the facility and processed in a production line. The apparatus is permanently affixed to a base or the floor of a production area.

Another embodiment of the invention is a mobile agricultural application where the apparatus can be installed on different types of tractors or other agricultural implements. An immediate handling and machining in the field is possible. Further, apparatus tolerances are developed to allow for some movement of the mobile platform base and/or a slow movement of the process throughout the field, much like the speed found in a combine or other farm implement machinery.

According to one aspect, an apparatus for processing broccoli florets is provided the apparatus typically includes a rotating head assembly including two or more clamping and cutting mechanisms, the head assembly rotating around a rotation axis. The apparatus also typically includes a plurality of receiving carrier cups configured to hold a broccoli head element, and a corresponding plurality of cup support mechanisms mechanically coupled to an elongated conveyor track, each cup support mechanism configured to support a receiving carrier cup, wherein the conveyor track rotates around the rotation axis at one end of the conveyor track. In typical operation, the cup support mechanisms travels along the conveyor track at a rate of speed defined by the rotation of the head assembly about the rotation axis, a head assembly clamping mechanism engages an unprocessed broccoli head element in a carrier cup, a cutting mechanism cuts the unprocessed broccoli head element to form a broccoli floret and a broccoli stem, and the head assembly clamping and cutting mechanisms align in a concurrent path with a receiving carrier cup prior to cutting the broccoli head element.

According to another aspect, a method is provided for processing broccoli florets the method typically includes placing broccoli heads in receiving cups mechanically coupled to a first conveyor and thereafter automatically transporting the cups around a head assembly device, clamping the broccoli heads with retractable clamps, and cutting the broccoli heads with a scooping motion of a curved blade in a curved path thereby creating a broccoli floret and a broccoli stem for each cut broccoli head element. The method also further typically includes automatically unclamping the broccoli heads by releasing retractable clamps, releasing the broccoli heads by a pivoting movement of the cups, and collecting the released broccoli head on a collecting conveyor.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an apparatus for processing broccoli florets according to one embodiment.

FIG. 2 illustrates a receiving cup according to one embodiment.

FIG. 3 shows a cup support track and a collecting track according to one embodiment.

FIG. 4 shows a carousel and head assembly according to one embodiment.

FIG. 5 shows a clamping assembly according to one embodiment.

FIG. 6 is a close up of the cutting assembly according to one embodiment.

FIG. 7 shows a top view of the head assembly according to one embodiment.

FIG. 8 illustrates how the blades approach the broccoli heads according to one embodiment.

FIG. 9 is a sequential view of the cutting process according to one embodiment.

FIG. 10 illustrates the scooping movement of the blade when it cuts off the florets of the broccoli head according to one embodiment.

FIG. 11 shows the machine in its entirety according to one embodiment.

FIG. 12 is a flowchart describing the severing process according to one embodiment.

FIG. 13 is a flowchart describing the rotation of the blades according to one embodiment.

FIG. 14 illustrates a method of floreting broccoli according to one embodiment.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The embodiments of the enclosed invention introduce an improved method and apparatus of floreting broccoli heads. Broccoli heads are individually placed in cups wherein the stems penetrate a bottom hole in the cup, and the head, which is centered and adhered in the dish of the cup, is cut or scooped off by blades while being transported around a carousel of the machine.

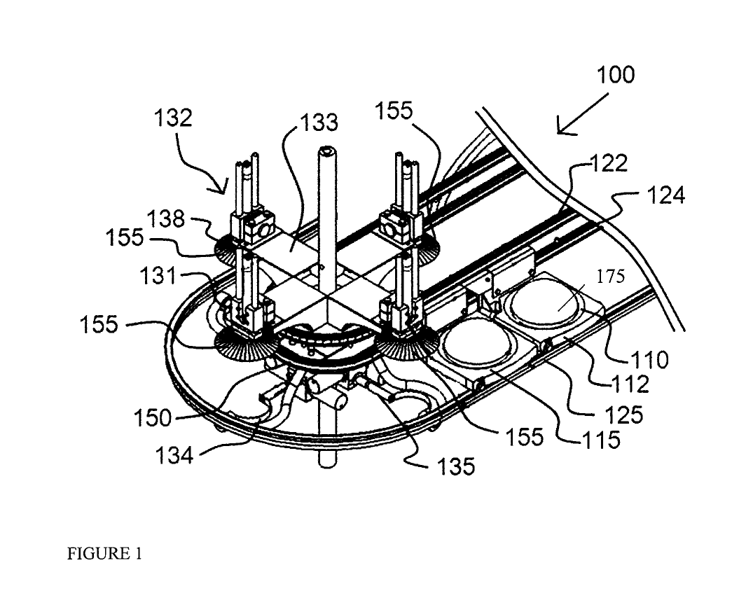

One embodiment of an apparatus for processing broccoli florets is illustrated in FIG. 1. The apparatus 100 for processing florets comprises a head assembly 132 including a plurality of linkages 133 (a twin pair of four-arm linkages is shown, however fewer or more linkages may be used) with associated clamping 138 and cutting mechanisms 134, at least one conjoined receiving carrier cup 110, a cup support mechanism 112 and a mechanically coupled conveyor track 122, a first and second collecting track 124, 125, and a carousel 150 around which the conveyor 122 and first collecting track 124 rotates. The first collecting conveyor 124 collects and removes dropped stems and the second collecting track 125 continuously removes dropped florets during the process. The head assembly 132 further comprises multiple (e.g., two, three, four or more) stations 131 that protrude from each end of the linkages 133.

Harvested broccoli is first cut into unprocessed head elements 175 and then placed in the receiving cups 110 by a field worker. The carrier assemblies 115 including receiving cups 110 and cup supports 112 are disposed evenly along the conveyor 122 and collecting tracks 124, 125 respectively and travel therewith, such that the head assembly clamping 138 and cutting mechanisms 134, operating beyond the outer perimeter of the carousel 150, engage a plurality of unprocessed broccoli head elements 175 to sever the unprocessed broccoli head elements and form a plurality of broccoli florets and related broccoli stems.

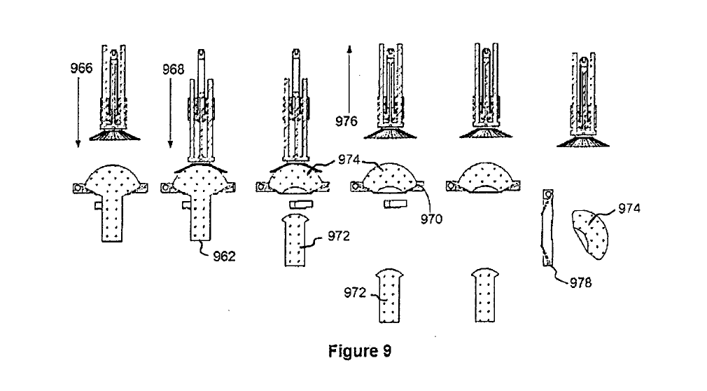

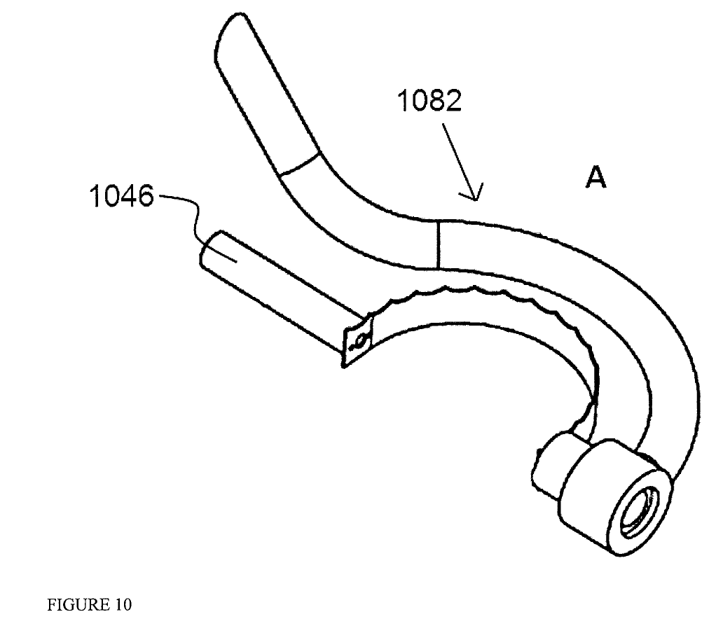

The unprocessed broccoli head elements 175 are engaged by the clamping mechanism 138 when the clamping mechanism 138 comes down and holds an unprocessed broccoli head element 175 in the cup 110. After clamping, the cutting mechanism blade 134 engages the unprocessed broccoli head element 175 and scoops the head from behind the unprocessed broccoli head element 175 resulting in the stem falling out the bottom onto a first collecting track conveyor 124. The broccoli head floret is then unclamped and the cup pivots and dumps the florets onto a separate second collecting track conveyor 125 for secondary processing, packaging and shipment. The carrier assemblies 115 and the clamping 138 and cutting mechanisms 134 are aligned in a concurrent path thereby creating rotating stations 155 comprising the carrier assembly 115, clamping 138 and cutting mechanisms 134. In the embodiment shown in FIG. 1, one station 155 is always not engaged with the upper track 122 and lower tracks 124. Clamping and cutting will be shown in more detail with reference to FIG. 9.

The broccoli head element processing stations 155 rotate one complete 360 degrees revolution in a continuous loop, at which time a new processing 360 degrees revolution is begun with a continuous feed of broccoli head element products 175 from carrier assembly 115 coupled to an associated conveyor track 122. The linkages travel at a speed synchronously interacting with an upper, cup support track 122 and lower, collecting track 124.

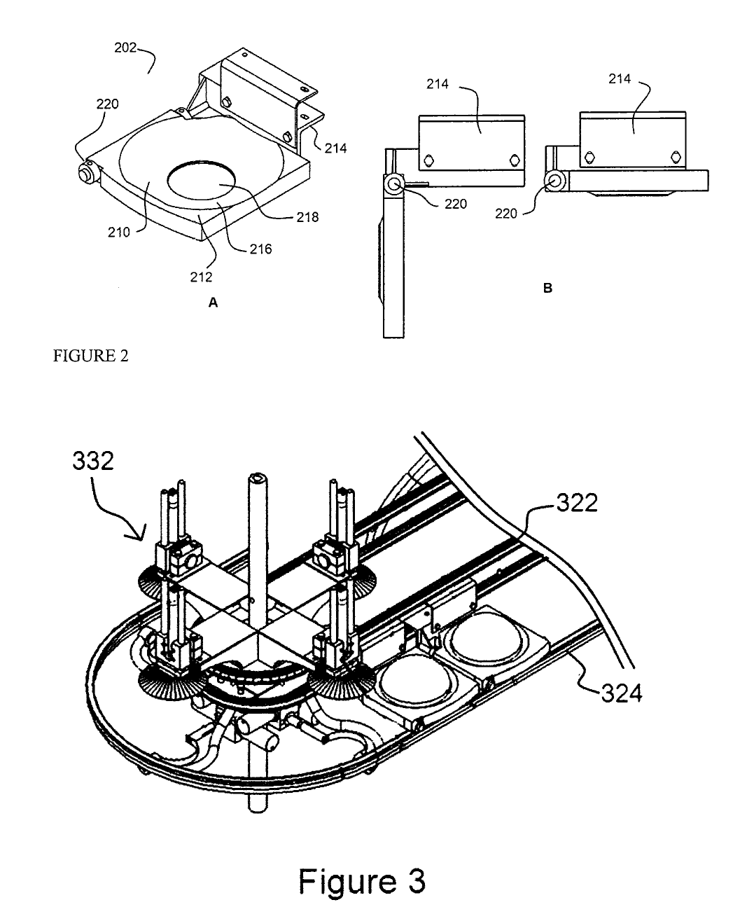

A carrier assembly 202 according to one embodiment is depicted in FIGS. 2a and 2b. FIG. 2a illustrates a perspective view a mounting cup assembly 212 in a second (horizontal) position, e.g., in which the cutting mechanism engages the unprocessed broccoli elements placed in the cup 212. FIG. 2b illustrates a side view of the mounting cup 212 in a first (vertical) position and in a second (horizontal) position wherein a cutting mechanism blade 234 engages the unprocessed broccoli element products. The carrier assembly 202 comprises a swiveling cup 210 enclosed in the mounting cup 212. One side of the cup assembly 212 is affixed to a retaining fixture 214. The cup 212 in one aspect, is pitted and exhibits a truncated cone-shaped dent 216 opening out in a round aperture 218 in its center to allow for placement of a broccoli head element in a way that the head can be engaged by the cutting mechanism blade. Opening 218 receives the broccoli heads that are placed on it whereby the stems are inserted through and the fanned out florets are held by the surrounding dent 216. The chamfer of the dent thereby serves as a standardizing penetration restriction and allows bigger broccoli heads less penetration compared to smaller broccoli heads.

The rotation of the cup is shown in FIG. 2b. A rotary hinge 220 enables the cup's rotation. The retaining fixture 214 again is affixed to a conveyor track and several cups are lined up on the track. Once the mounting cup assembly 212 moves from the first (vertical) position into a second (horizontal) position the carrier assembly 202 synchronously engages with the unprocessed broccoli head elements in the clamping mechanism.

FIG. 3 illustrates a cup support track 322. The carrier assemblies are affixed as shown to transporting cup support track 322. Further, the transporting cup support track 322 may also be viewed as a conveyor 322 because the carrier assemblies are affixed to the track and thereby conveyed from one broccoli element processing station to the next. This conveyor 322 in one aspect is an oval track, when viewed from the top as a plan view, rotating around the carousel of the machine. By this conveyor means 322, the consecutively aligned broccoli heads are, one by one, transported through the cutting station defined by head assembly 332.

FIG. 3 further illustrates a collecting track 324 located underneath the cup supporting conveyor track 322. The collecting track 324 gathers the stems that were cut off and is in a lower level but parallel to the cup supporting track, typically traveling concurrently and in synchronous speeds with the cup supporting track 322.

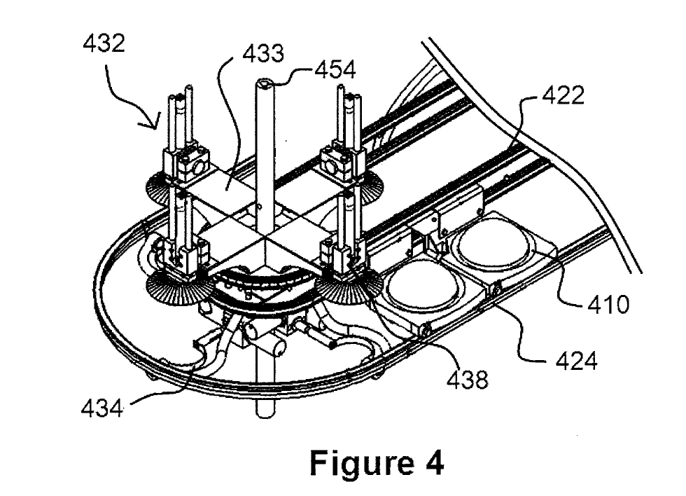

FIG. 4 illustrates a carousel and a head assembly 432 according to one embodiment. The head assembly 432 in one aspect includes a double set of bar, arm linkages 433. Each set has four arms that are crosswise arranged around a center of rotation 454. This center is one of the pivot points of the carousel of the machine. At the end of each arm of the upper linkage a clamping device 438 is affixed and on the lower linkage a cutting device 434. As shown in FIG. 4, the conveyor 422, the receiving cups 410, and the collecting track 424 rotate around the head assembly 432 concurrently and at synchronous speeds such that a broccoli head element in a cup 410 rotates synchronously with the clamping and cutting mechanisms. The head assembly 432 rotates in the carousel around which the conveyor 422 and the collecting tracks 424 rotate. The receiving cups 410 are disposed evenly along the conveyor 422 respectively and traveling therewith, such that the head assembly 432 and the associated clamping 438 and cutting mechanisms 434 engage an unprocessed broccoli head to cut the unprocessed broccoli head and form a broccoli floret and a broccoli stem. The head assembly clamping and cutting mechanisms are further aligned in a concurrent path prior to cutting the element at synchronized rates of speed. After one complete revolution, a new processing 360 degrees revolution is begun with a continuous feed of broccoli head element products.

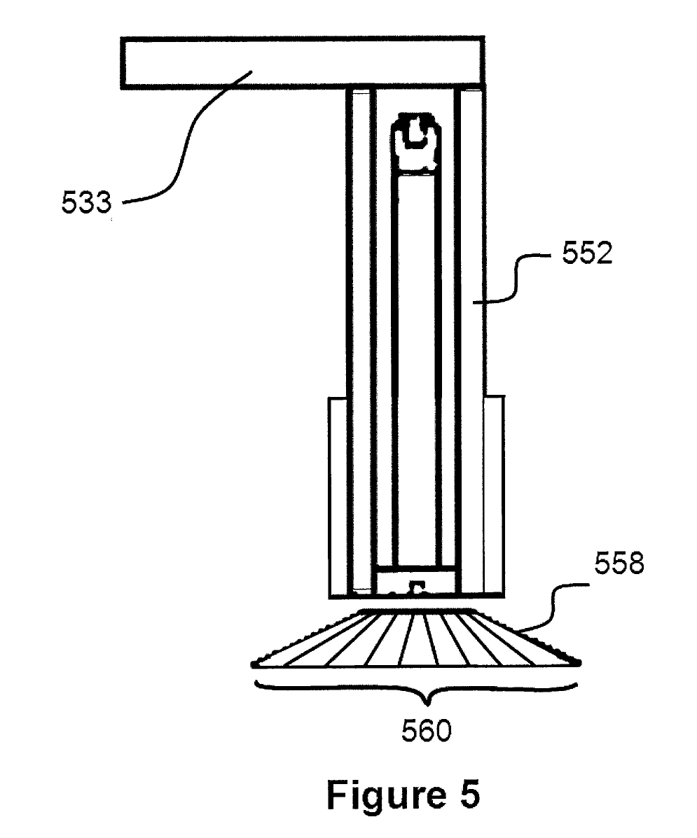

FIG. 5 illustrates a clamping assembly according to one embodiment. A lowering rig 552 is affixed to the end of each arm 533 of the upper linkage and includes a clamp 558. The rig 552 enables the engaging (e.g., up and down) movement of the clamp. Clamp 558 in one aspect is adjustable and can fasten and thereby decrease their cross section dimension 560. Due to the movement of the rig, the clamp is subsided and positioned on the broccoli head. The clamp's constriction avoids movement of the broccoli heads and holds the heads in a stable position tight in the receiving cups throughout their transportation around the head assembly.

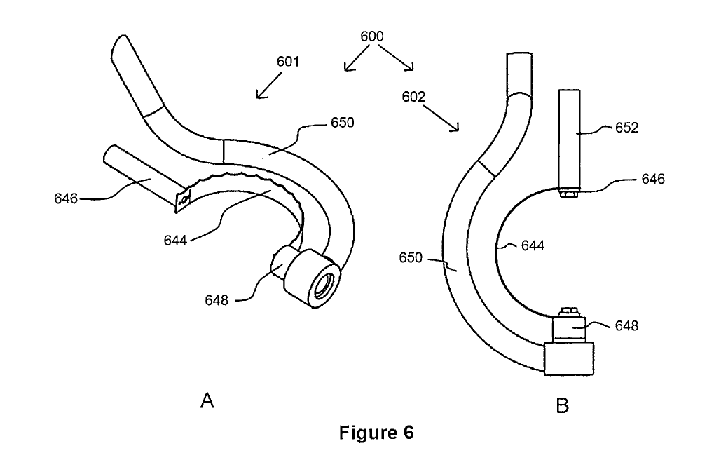

FIG. 6 illustrates a perspective view (A) 601 and a top plan view (B) 602 of cutting assembly 600 according to one embodiment. In one aspect, cutting assembly 600 includes a curved blade 644 affixed between an inner blade pivot 646 and an outer blade pivot 648. The outer side of the blade is backed with a blade support 650. The inner pivot 646 connects to a handle 652 which is installed at each end of the lower linkage that is crosswise arranged around a center of rotation. This fixation is typically positioned on the lower portion of the head assembly and above the transporting track. In one aspect, the blade's radius equals the recess curve of the bottom side of the receiving cups.

Due to the curved shape of the blades 644, the florets are severed in a curved path. In one aspect, the cutting surface is along the reverse side of the carrier assembly. This pre-determined profile of cutting surface enables a standardized size result of the accumulated florets.

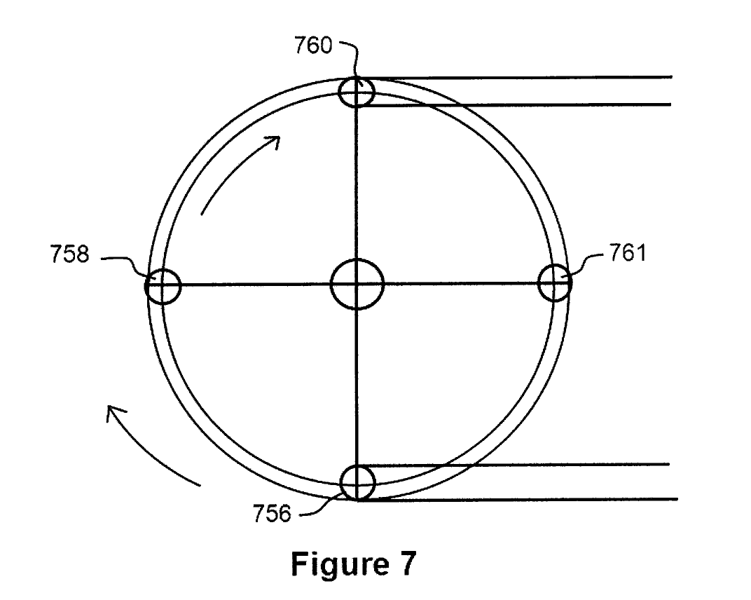

The cutting assembly and the clamping linkage rotate synchronously around the axis of the head assembly, as shown in FIG. 7. In a first position 756 the clamp-cutting pairing lines up with the path of the conveyor and, in particular, the carrier cup with the broccoli head such that the cutting mechanism engages the broccoli head element. This pairing stays in a concurrent motion with the cup around the angular point and up to a second position 758.

Due to the equal pace of upper and lower linkage and the conveyor the clamps adhere to the broccoli heads throughout their rotation around the head assembly. During this passage the blades can accomplish the cutting action to produce florets.

After reaching the third position 760, the pairing keeps rotating on its path whereas the conveyor track transports the broccoli straightforward traveling along the linear portion of the conveyor. Prior to or at position 760, the clamps release the held florets, and the clamps and blades subsequently travel to non-processing station 761 and then re-converge with the conveyor in the first position 756.

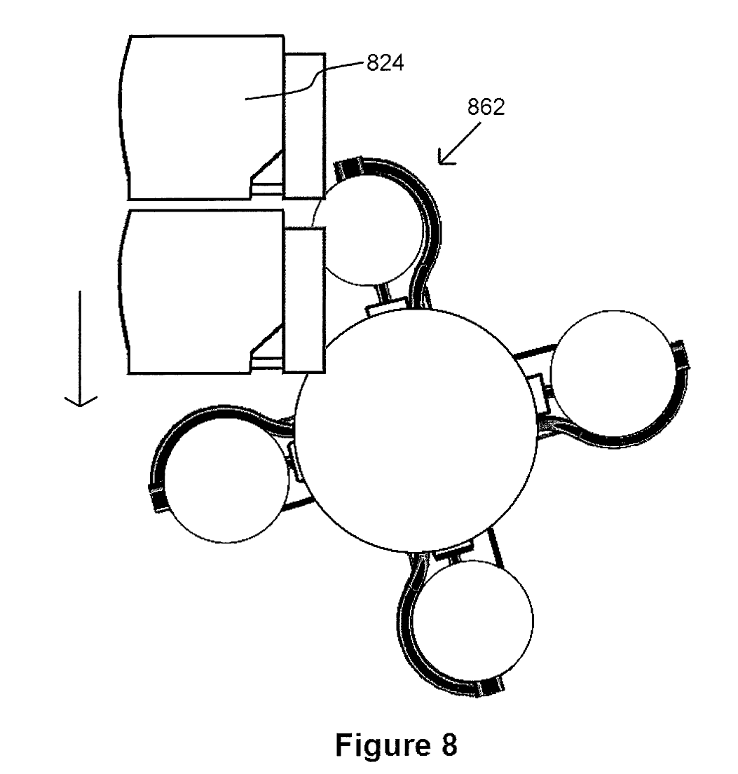

FIG. 8 illustrates a broccoli cutting process according to one embodiment. The broccoli heads are placed stem down into the receiving cups and are transported along the track 824. Close to the head assembly, converging on the first position the cutting blades approach the broccoli heads in a rotary motion from behind 862 as shown in FIG. 8. When the blades align with the center of the broccoli heads the cutting motion commences. In one aspect, the blades rotate around an axis defined by elements 646 and 648 (see FIG. 6) to scoop and cut the head from the stem to produce florets. Approaching from behind and scooping the broccoli head element provides for an efficient cut.

Simultaneously, when the broccoli heads approach the first position, the clamping rigs are being armed out 966 as shown in FIG. 9. In this first step of the cutting process the rigs extend until the clamps that are affixed at the rigs' lower end reach the broccoli heads. Fully extended they are in a position to engage or clamp the heads 968 and adhere to them during the subsequent cutting process. During the one-hundred eighty degrees rotation of the heads around the head assembly and the cutting operation itself the clamps follow the position of the heads synchronously.

The broccoli head elements are clamped 968 such that the broccoli head elements are held securely into place to prevent movement and to increase product stability, directly resulting in a more efficient cut.

Due to the bonding and common movement of the upper and lower linkages in one aspect, the cutting assembly also approaches the broccoli head from behind 962 to synchronize with the location and travel of the clamping and cutting mechanisms as further shown in FIG. 9. This approximation and approach from the rear of the broccoli head element enables unrestricted front access to the heads and, consequently, cleaner cuts. While the blade follows the track on a one-hundred and eighty degrees rotation around the axis, the blade slowly revolves around its pivot point 970 and scoops the broccoli head off of the stem.

Upon cutting, the separated stems 972 fall out of the bottom of the receiving cups. On a second conveyor layer positioned underneath the assembly carrier, the cut off stems are collected and can be used for subsequent treatment.

The separated florets 974 remain clamped in the receiving cups until the head is unclamped. The clamps release the heads when the rigs are ratcheting up 976. This comes to pass shortly before the receiving cups pivot around the assembly's end point. The cups then swing down 978, pivoting around the rotary axes in their first longitudinal side and, thereby, dump the florets 974 onto a separate conveyor.

Now referring back to FIG. 1 to illustrate another aspect of the present invention. The apparatus for processing broccoli florets includes an upper clamping linkage, and a lower blade linkage, wherein the head assembly 132 includes a twin pair of bar, arm linkage 133 that is rectangular, crosswise arranged around a center of rotation, such that the four-arm linkage and related head assembly are mechanically coupled and rotatably engage a continuous feed of broccoli head element products. The broccoli head elements travel beyond the outer perimeter of the carousel 150. The lower blade linkage 135 engages the broccoli head element from behind to separate the broccoli head element by a scooping motion into a broccoli floret and a broccoli stem thereby cutting the broccoli head element at a location proximate to the first position 756 as shown in FIG. 7.

The cutting process itself is, in one aspect, a scooping movement of the blades as more specifically shown in FIG. 10. From the blades pre-employed position 1082, the blade rotates around its inner blade pivot 1046 to a rear position where the blade engages the broccoli head element at the bottom edge of the cup in a scooping motion behind the broccoli head element. In the rotating scooping motion, the blade follows the bottom edge of the transporting cup until the unprocessed broccoli head element is severed into a stem and a floret. FIG. 9 further illustrates the stem 972, and floret 974.

Referring now to FIG. 7 as well as FIG. 10, the blade position is more clearly shown with respect to the broccoli head element. In the range where the clamp-blade pairing diverges from the track between the third position 760 and the first position 756, the blade of the cutting assembly pivots around its axis and resets back into its original position 1082, 756. The blade swings from its after-cutting rear position to a pre-cutting front position 1082. As the pairing comes around and reassembles with its path with the chain, the blade finished this one-hundred eighty degrees rotation and is in position to floret another approaching broccoli head.

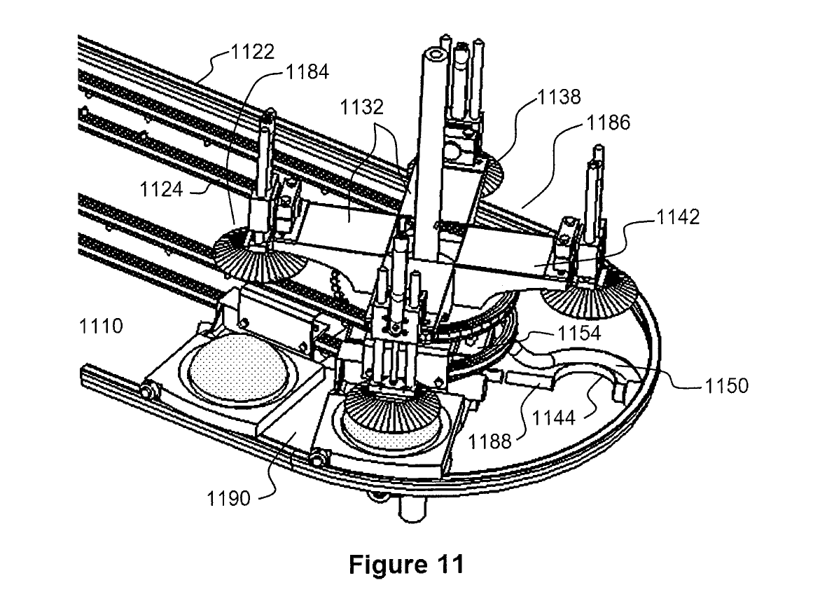

In another aspect of the invention, the apparatus for processing broccoli florets shown in FIG. 11 includes the lower blade linkage 1154, further comprising a plurality, e.g., four, rotatably affixed, curved blades 1144 each supported by blade supports 1150, attached to arms of the linkage such that the lower blade linkage 1154 travels concurrently with the rotatably affixed upper arm linkage 1142 and its clamping mechanism 1138 such that the two arm mechanisms rotate from a first position 1186 to a second position 1188 to a third position 1190 and subsequently to a fourth position 1184. Upon the rotation of one complete 360 degrees revolution, the clamp-cut pairing passes through the first position 1186, at which time a new processing 360 degrees revolution is begun. The synchronization speeds of the upper and lower linkage could accommodate more or less processing stations (e.g., linkages with clamping and cutting mechanisms) in other embodiments.

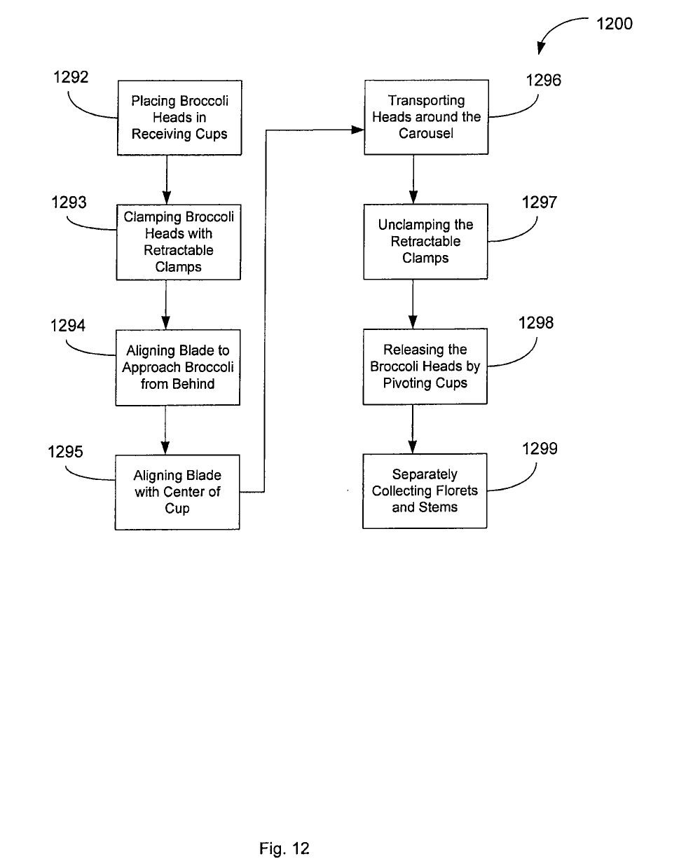

In another embodiment, a method for implementing the apparatus for processing broccoli florets comprises the following steps shown in FIG. 12: placing the broccoli heads stem in the receiving cups 1292; clamping the broccoli heads with retractable clamps (e.g., from above) 1293; aligning the blade to approach the broccoli element (e.g., from behind) 1294 and then aligning with the center of the cup 1295; cutting the broccoli heads (e.g., with a scooping motion of the curved blades in a curved path) while the cups are transporting the broccoli heads around the carrousel of the device 1296; unclamping the broccoli heads by releasing the retractable clamps 1297; releasing the broccoli heads by a pivoting movement of the cups 1298; and collecting the cut off stems on a second conveyor means such that the florets and stems are collected into separate zones 1299.

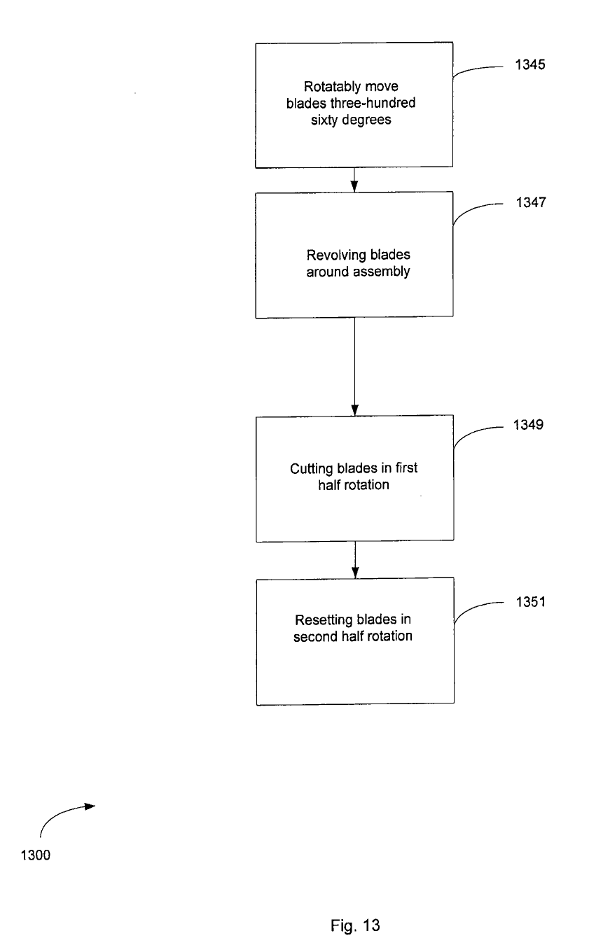

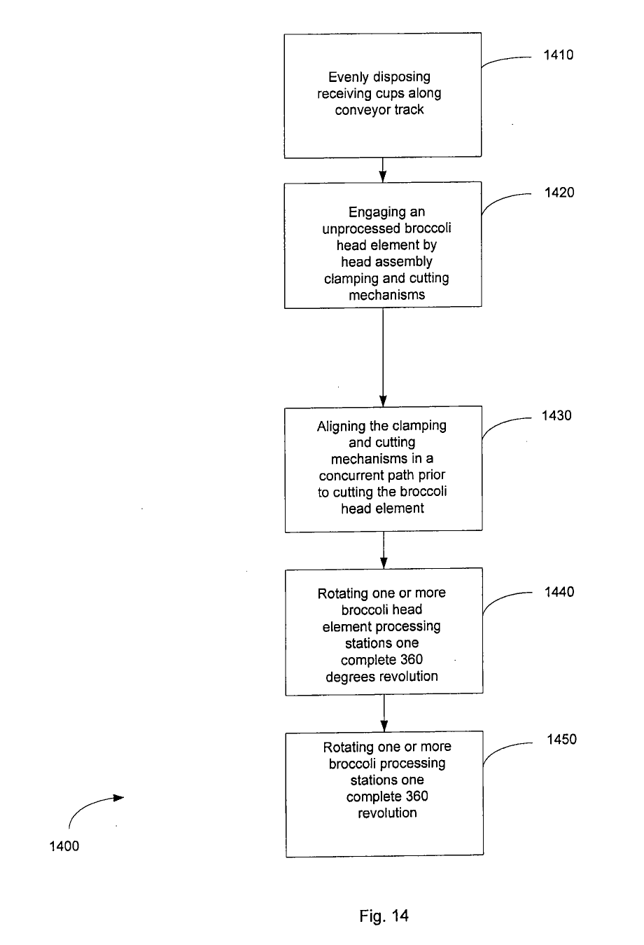

In another aspect of the present invention, a method for implementing the apparatus for processing broccoli florets is shown in FIGS. 13 and 14. Referring back to FIG. 11, the upper 1142 and the lower linkage 1154 act jointly enabled by their congruent and concurrent movement such that the receiving cups 1110 are disposed evenly along the conveyor track 1122 respectively and traveling therewith. FIG. 13 describes the motion of cutting blades during a complete rotation of the head element assembly and is further detailed below. FIG. 14 describes an overall process of engaging unprocessed broccoli head elements in receiving cups with clamping and cutting mechanisms 1400. Step 1410 shows evenly disposing the receiving cups 1110 along the conveyer track 1122. Step 1420 shows engaging an unprocessed broccoli head element by the head assembly clamping 1138 and cutting mechanisms 1144 to sever the unprocessed broccoli head element and form a broccoli floret and a broccoli stem. In step 1430, the head assembly clamping 1138 and cutting mechanisms 1144 travel synchronously, aligning in a concurrent path prior to cutting the element. Step 1440 illustrates rotating one or more broccoli head element processing stations of one complete 360 degrees revolution, at which time a new processing 360 degrees revolution is begun as shown in Step 1450.

In a further aspect of the present invention, shown in FIG. 13, the method for implementing the apparatus for processing broccoli florets also includes: providing a 360 degrees revolution movement of the blades 1345; revolving the blades around the head assembly 1347; cutting the broccoli head elements in a first half rotation 1349 to create the separation of the broccoli florets and stems; rotating the blades in a second one-hundred eighty degrees rotation 1351 enabling the blades to reset to their original position; and extending and retracting rigs to enable a vertical adjustment of the clamps.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. For example, embodiments and aspects of the present invention are useful for cutting cauliflower heads. For cauliflower heads, one or more blades that create a “V” cut to remove the core from the florets may be desirable. Accordingly, it is appropriate that the appended claims be construed broadly and in a manner consistent with the scope of the invention, as set forth in the following claims.

What is claimed is:

1. An apparatus for processing broccoli florets, comprising:
a rotating head assembly including two or more clamping and cutting mechanisms, the head assembly rotating around a rotation axis;
a plurality of receiving carrier cups configured to hold a broccoli head element; and
a corresponding plurality of cup support mechanisms mechanically coupled to an elongated conveyor track, each cup support mechanism configured to support a receiving carrier cup, wherein the conveyor track rotates around the rotation axis at one end of the conveyor track;
wherein the cup support mechanisms travels along the conveyor track at a rate of speed defined by the rotation of the head assembly about the rotation axis, wherein a head assembly clamping mechanism engages an unprocessed broccoli head element in a carrier cup, wherein a cutting mechanism cuts the unprocessed broccoli head element to form a broccoli floret and a broccoli stem, and wherein the head assembly clamping and cutting mechanisms align in a concurrent path with a receiving carrier cup prior to cutting the broccoli head element.

2. The apparatus of claim 1, wherein the cup support mechanisms are disposed evenly along the conveyor track.

3. The apparatus of claim 1, wherein the head assembly includes two or more arm linkages that extend radially away from the rotation axis each arm linkage including a clamping mechanism and an associated cutting mechanism located proximate an end of the arm.

4. The apparatus of claim 3, wherein each clamping mechanism includes and adjustable clamp, wherein the clamp is configured to engage a broccoli head element held in a receiving cup where said cup is located proximal to the clamp and simultaneously rotating around the rotation axis with the clamp.

5. The apparatus of claim 4, wherein each cutting mechanism includes a curved blade configured to cut a clamped broccoli head while the clamped head is rotating around the rotation axis.

6. The apparatus of claim 5, wherein each curved blade has a radius equal to the recess curve of the bottom side of said cup.

7. The apparatus of claim 1, wherein each receiving cup includes a truncated cone-shaped chamfer whose diameter facilitates receiving a broccoli head.

8. The apparatus of claim 1, further comprising:
a collecting track that gathers the cut off stems in a lower level, substantially parallel to and underneath at least a portion of the cup supporting track.

9. The apparatus of claim 3, wherein the cup support mechanisms and cutting and clamping mechanisms rotate synchronously around the rotation axis.

10. The apparatus of claim 3, wherein the head assembly comprises four arm linkages.

11. The apparatus of claim 1, wherein the receiving carrier cups are configured to receive broccoli heads with the stem pointing down.

12. A method for processing broccoli florets comprising the following steps:
placing broccoli heads in receiving cups mechanically coupled to a first conveyor and thereafter automatically:
transporting the cups around a head assembly device;
clamping the broccoli heads with retractable clamps;
cutting the broccoli heads with a scooping motion of a curved blade in a curved path thereby creating a broccoli floret and a broccoli stem for each cut broccoli head element;
unclamping the broccoli heads by releasing retractable clamps;
releasing the broccoli heads by a pivoting movement of the cups; and
collecting the released broccoli head.

13. The method of claim 12, wherein the released broccoli head is collected on a collecting conveyor.

14. The method of claim 12, further including collecting broccoli stems on a collection conveyor.

15. The method of claim 12, wherein the receiving cups are configured to receive broccoli heads with the stem pointing down.
